(19) United States
(12) Patent Application Publication
(10) Pub. No.: US 2024/0324826 A1
(43) Pub. Date: Oct. 3, 2024

(54) Link Cutting and Food Prep Board

(71) Applicant: John Thomas Rowan, Peoria, AZ (US)

(72) Inventor: John Thomas Rowan, Peoria, AZ (US)

(21) Appl. No.: 18/623,914

(22) Filed: Apr. 1, 2024

Related U.S. Application Data
(63) Continuation-in-part of application No. 29/873,413, filed on Mar. 30, 2023.
(60) Provisional application No. 63/493,044, filed on Mar. 30, 2023.

(51) Int. Cl. A47J 47/20; A47J 47/00

(52) U.S. Cl. CPC A47J 47/20; A47J 47/005

(57) ABSTRACT

Disclosed is a food prep board that is comprised of two components, a board and a tray. The food prep board is designed to be built into ones counter that abuts the sink so that one can easily scrape left over food particles directly into the sink with ease to be put down the disposal. The board has a divot that is perimetrically engraved into the top side of the board. The board has multiple divots on the underside of the board. The tray is a flat panel that has wall one 3 sides of the tray. The side that abuts the sink does not have a wall. The tray is designed with mounting posts that extend up from the panel and are configured to rest within the multiple divots that are cut into the underside of the board.

### FIELD OF THE INVENTION

The present invention relates generally to kitchen utensils. More specifically the present invention is a kitchen cutting board integrated into the countertop and adjacent to undermount kitchen sinks.

### BACKGROUND OF THE INVENTION

Kitchen cutting and prep boards are useful tools for the home and commercial kitchens. Currently, cutting and prep boards for the home are usually mobile and placed on counters when needed and often stored when not in use. When used on a home kitchen counter, these boards are unstable and move when used providing an unstable prep and cutting area. In commercial kitchens, cutting and prep tables are commonly permanently placed in prep areas giving the commercial chef a stable, knife friendly, prep area, conveniently located where they work. These work areas are designed to be easily cleaned and are permanently positioned in their workspaces.

This invention is designed to give the home kitchen a permanent prep and cutting area built into the countertop, adjacent to an undermount sink, and overlapping over and into the sink for drainage. The integrated position next to the sink means the board never has to move and stays dry by draining into the sink when used. This gives the home a stable cutting and prep area built in, stable, and permanently where a home cook uses it the most, next to the sink. This integrated cutting and prep area is stable yet easily removed for cleaning. Being positioned next to the kitchen sink allows for easy food collection and gives the kitchen a permanent and stable knife friendly area the home owner can use at anytime.

An objective of the present invention is the provide a cutting board that has a counter installed mount next to a kitchen undermount sink. The tray has mounting components that protrude out the tray base. The cutting board itself has cut outs which are configured to align with the mounting components of the installed tray in the countertop. This alignment of the cutouts and mounting elements allows the cutting board to remain stationary while in use. There is a drainage channel cut around the outside of the upper surface that routes liquid into the sink. The board is elevated from the base and air channels are cut in the under surface to keep the area under the board dry and clean.

The board overhangs into the sink so allow easy food collection without moving the board.

### BRIEF DESCRIPTION OF THE DRAWINGS

FIG. 1 is an isometric perspective view of the cutting board of the present invention.

FIG. 2 is bottom view of the cutting board of the present invention.

FIG. 3 is a top view of the tray of the present invention.

FIG. 4 is bottom-right-rear view of the cutting board of the present invention.

FIG. 5 is a bottom-right-front view of the tray of the present invention.

FIG. 6 is a right view of the cutting board of the present invention.

FIG. 7 is a left view of the cutting board of the present invention.

FIG. 8 is a bottom view of the tray of the present invention.

FIG. 9. is a right view of the tray of the of the present invention.

FIG. 10. is a left view of the tray of the of the present invention

FIG. 11 is a rear view of the present invention with the cutting board on the tray.

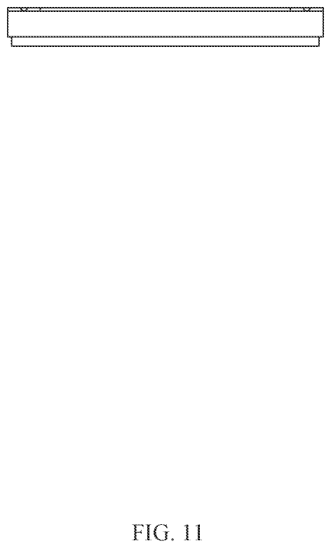

FIG. 12 is a front view of the present invention with the cutting board on the tray.

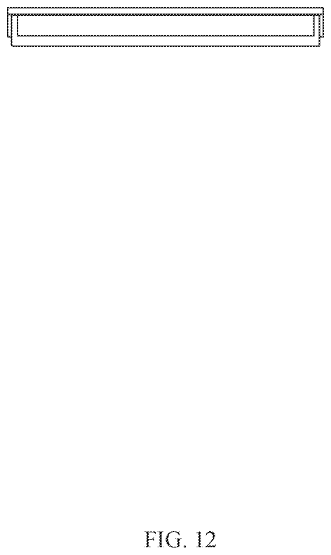

### DETAIL DESCRIPTIONS OF THE INVENTION

All illustrations of the drawings are for the purpose of describing selected versions of the present invention and are not intended to limit the scope of the present invention.

The present invention provides a food prep board 1 and tray 3 device for preparing food and other items. The present invention provides a tray 3 that has protrusions positioned in each corner of the tray 3. The tray 3 is designed to be permanently installed into ones countertop next to an undermount kitchen sink. In order to ensure the tray 3 remains stationary while in use, the cutting board 2 has cut outs that align with the protrusions.

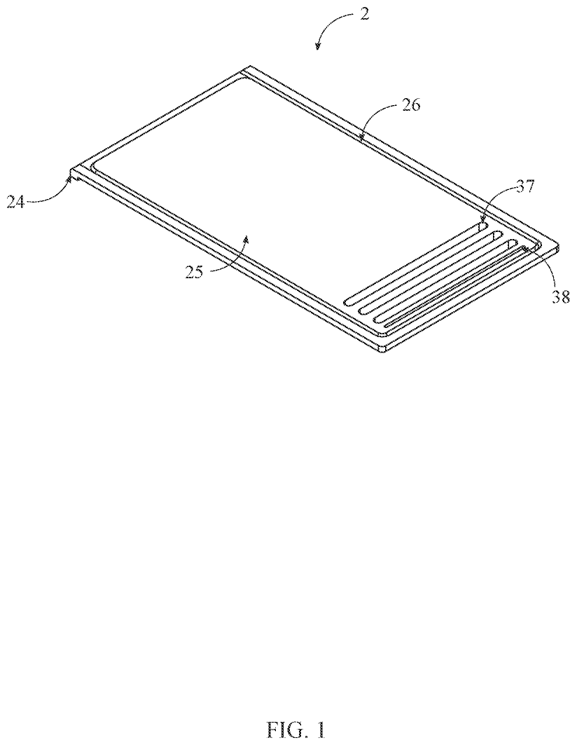

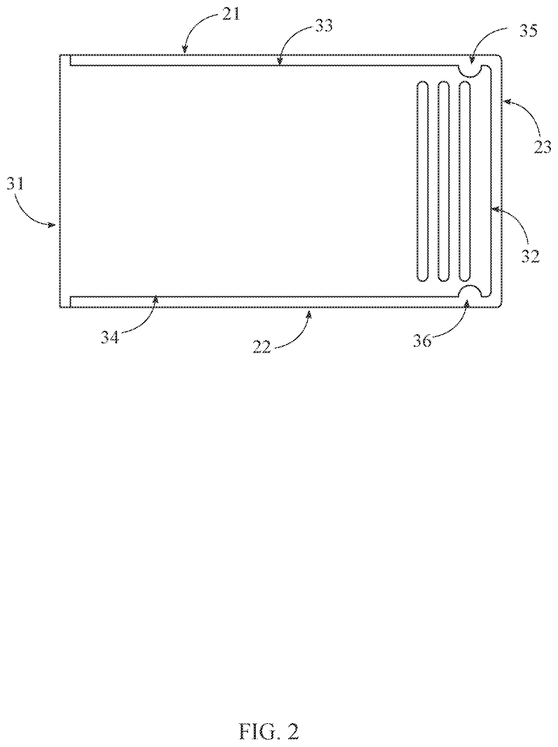

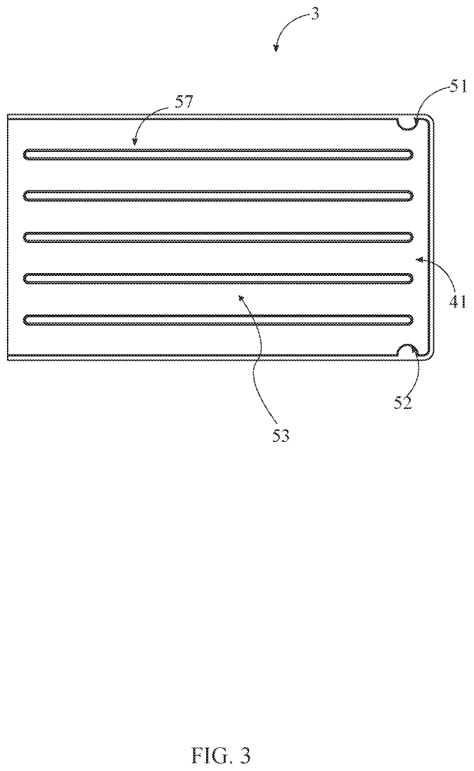

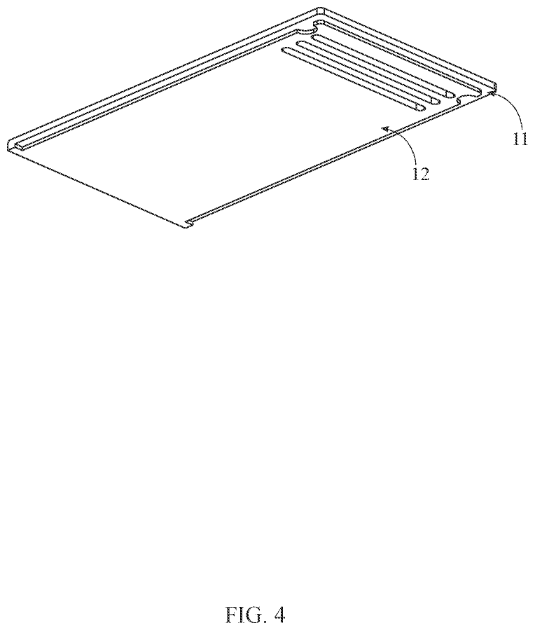

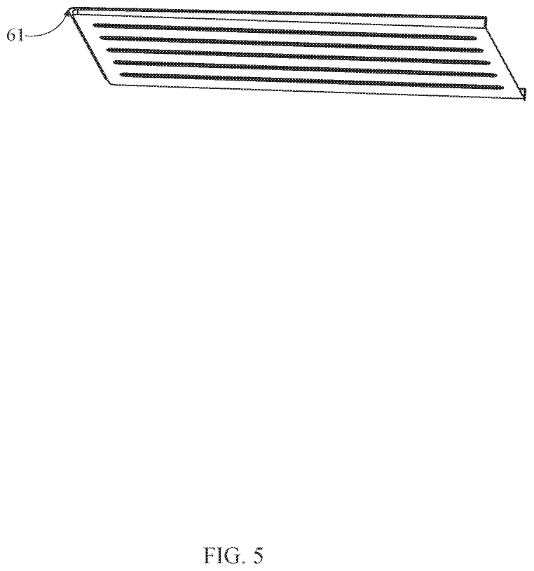

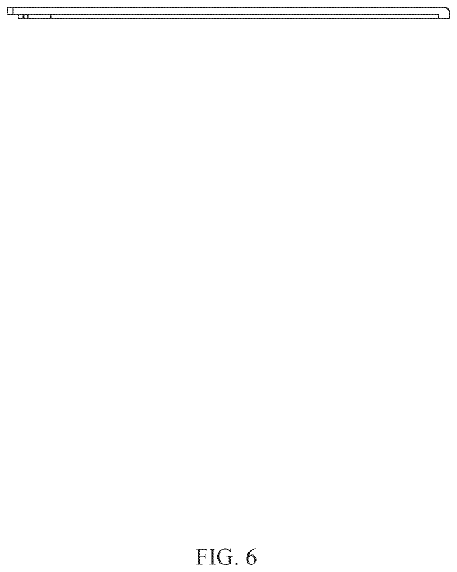

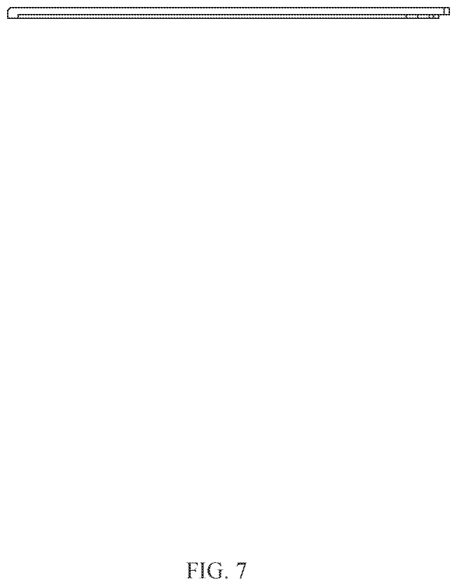

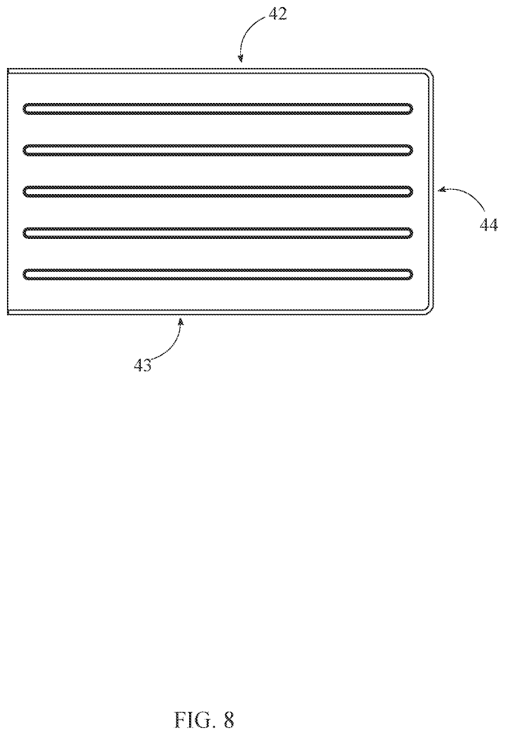

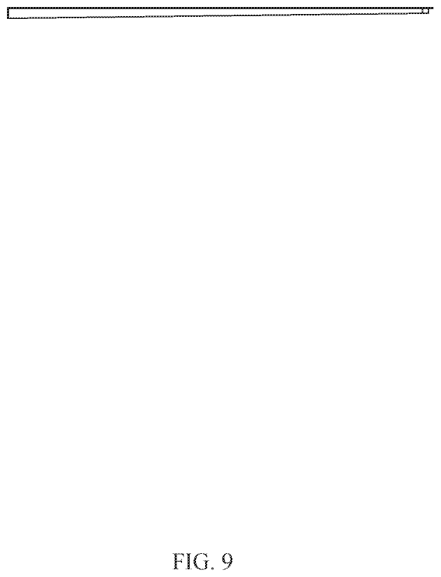

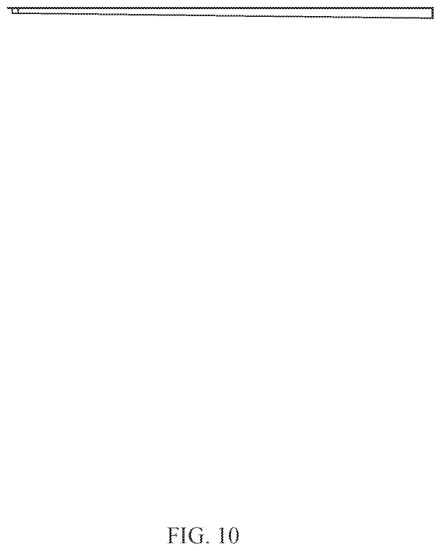

As can be seen in FIGS. 1-10, the cutting board 2 unit comprises two components, the tray 3 and the cutting board 2. The cutting board 2 is designed to rest on top the tray 3 underneath. In the preferred embodiment, the invention will be installed into ones countertop directly next to the sink. This is done so that when one is done cutting the food item being prepared, the scraps and trimmings can be swept into the sink to be put down the disposal. The present invention can be installed in any countertop with an undermount sink.

The cutting board 2 is configured to be slightly larger than the tray 3 ensuring the tray 3 is fully covered when in use. The cutting board 2 can be made out of wood or molded plastic. The cutting board 2 can have any name or image engraved in it should the user opt to have it. The cutting board 2 has an upper panel 11 and a lower panel 12. The upper panel 11 is larger than the lower panel 12. This design enables that the lower panel 12 will rest within the tray 3, keeping the board in place while in use. The upper panel 11 is centrally positioned on the lower panel 12. The cutting board 2 has a divot 26 that is located on the top surface 25 of the cutting board 2. The divot 26 is perimetrically positioned about the top surface 25. The divot 26 is offset from the edge and travels the entire perimeter of the cutting board 2.

The cutting board 2 is flat and is also defined by two sets of parallel sides of different lengths. This provides that the board has the same shape as the tray 3 beneath it. The upper panel 11 of the cutting board 2 is comprised of a rear edge 23, a right edge 22, a left edge 21 and a front brim 24. Along one of the shorter sides of the cutting board 2, the cutting board 2 is bent downward forming the front brim 24. When the board is installed in position, the front brim 24 aligns up with the short side of the tray 3 that does not possess a sidewall. The rear edge 23 is positioned between the left edge 21 and the right edge 22 and the front brim 24 being positioned between the left edge 21 and the right edge 22 opposite the rear edge 23. This configuration forms the rectangular shape of the cutting board 2.

The lower panel 12 is defined by a front wall 31, a right wall 34, a rear wall 32, and a left wall 33. The front wall 31 is positioned between the left wall 33 and the right wall 34. The rear wall 32 is positioned between the left wall 33 and the left wall 33 opposite the front wall 31. The lower panel 12 comprises a first indent 35 and a second indent 36. The left indent 35 is positioned along the left wall 36 where it connects to the front wall 31. The right indent 36 is positioned along the right wall 34 where it connects to the front wall 31.

The cutting board 2 has a plurality of drainage slots 37 that are positioned adjacent to the rear edge. These drainage slots 37 allow any food particles, juices, and remnants to be scraped across the cutting board 2 and drop to the tray 3 below. The tray 3 that sits below the cutting board 2 is angled slightly, which allows the food particles to run down the tray and into the sink. A knife holding slit 38 is positioned between the plurality of drainage slots 37 and the rear edge 23. This allows the user of the cutting board 2 to insert the knife blade in the knife holding slit 38 and have it rest there until the knife is needed again. The knife holding slit 38 is narrower than each of the plurality of drainage slots 37.

The cutting board 2 can be used over a sink by itself without the need for a tray 3 underneath. This is an added function of the front brim 24 of the cutting board 2. The front brim 24 of the cutting board 2 can be positioned over a sink wall if one has a double basin sink.

In its preferred embodiment the tray 3 is made out of metal or any material that maintains the integrity of the invention. The tray 3 is defined by two sets of parallel walls and is positioned flat in ones countertop. The two sets of parallel walls are different lengths forming a rectangular shape.

The tray 3 has a low profile wall that travels around three sides of the tray 3. The tray 3 comprises a base panel 41, a left barrier 42, a right barrier 43, and a rear barrier 44. The base panel 41 has a top side 53 and a bottom side 54. A plurality of slides 57 are spaced across the top side 53 of the tray 3. The plurality of slides 57 traversing the length of the top side of the tray 3. The tray 3 further comprising a left mounting post 51 and a right mounting post 52. Having multiple mounting posts that are designed to engage with the indents on the bottom of the cutting board 2 is what ensures the cutting board 2 does shift around when being used.

The right barrier 43 has a front end 47 and a rear end 48 and the left barrier 42 has a front end 45 and a rear end 46. The rear barrier 44 being positioned between the rear end 48 of the left barrier 42 and rear end 48 of the right barrier 43. The right mounting post 52 is positioned along the right barrier 43 where it connects to the rear barrier 44. The left mounting post 51 being positioned along the left barrier 42 where it connects to the rear barrier 44. The right mounting post 52 extends inward on the tray. The left mounting post 51 extends inward on the tray. The right mounting post 52 and the left mounting post 51 will sit within the right indent 36 and the left indent 35 of the cutting board. The tray further comprises a lip 61. The lip 61 traverses the length of the left barrier 42, the rear barrier 44, and the right barrier 43.

On the fourth side of the tray 3, it has no sidewall. The side of the tray 3 that has no sidewall is the side that abuts the kitchen sink.

Although the invention has been explained in relation to its preferred embodiment, it is to be understood that many other possible modifications and variations can be made without departing from the spirit and scope of the invention.

What is claimed is:

1. A food prep board comprising:
a cutting board;
a tray;
the cutting board configures to rest on top of the tray;
the cutting board further comprising an upper panel and a lower panel;
the upper panel having a left edge, a right edge, a rear edge, and a front brim;
the upper panel having a top surface; and
a divot being perimetrically positioned about the top surface.

2. The food prep board as claimed in claim 1 comprising:
the upper panel being larger than the lower panel;
the upper panel being centrally positioned on top of the lower panel;
the rear edge being positioned between the left edge and the right edge;
a plurality of drainage slot being positioned adjacent to the rear edge;
a knife holding slit being positioned between the plurality of drainage slots and the rear edge;
the knife holding slit being narrower than each of the plurality of drainage slots;
the plurality of drainage slots traversing through the upper panel and lower panel of the cutting board; and
the front brim being positioned between the left edge and the right edge opposite the rear edge.

3. The food prep board as claimed in claim 1 comprising:
the lower panel having a front wall, a right wall, a rear wall, and a left wall;
the front wall being positioned between the left wall and the right wall;
the rear wall being positioned between the left wall and the left wall opposite the front wall;

4. The food prep board as claimed in claim 1 comprising:
the lower panel comprising a, first indent and a second indent;
the lower panel comprising a right indent and a left indent;
the left indent being positioned along the left wall where it connects to the front wall; and
the right indent being positioned along the right wall where it connects to the front wall.

5. The food prep board as claimed in claim 1 comprising:
the tray comprising a base panel, a left barrier, a right barrier, and a rear barrier;
the base panel having a top side and a bottom side;
a plurality of slides are spaced across the top side of the tray;
the plurality of slides traversing the length of the top side of the tray; and
the tray further comprising a left mounting post and a right mounting posts.

6. The food prep board as claimed in claim 5 comprising:
the right barrier having a front end and a rear end;
the left barrier having a front end and a rear end; and
the rear barrier being positioned between the rear end of the left barrier and rear end of the right barrier.

7. The food prep board as claimed in claim 6 comprising:
the right mounting post being positioned along the right barrier where it connects to the rear barrier;
the left mounting post being positioned along the left barrier where ti connects to the left barrier;
the right mounting post extending inward on the tray;
the left mounting post extending inward on the tray;
the tray having a lip; and
the lip traversing the length of the left barrier, the rear barrier, and the right barrier.

8. The food prep board comprising:
a cutting board;
a tray;
the cutting board configured to rest on top of the tray;
the cutting board further comprising an upper panel and a lower panel;
the upper panel having a left edge, a right edge, a rear edge, and a front brim;
the upper panel having a top surface;
a divot being perimetrically positioned about the top surface;
the upper panel being larger than the lower panel; and
the upper panel being centrally positioned on top of the lower panel.

9. The food prep board as claimed in claim 8:
the rear edge being positioned between the left edge and the right edge
the front brim being positioned between the left edge and the right edge opposite the rear edge;
the lower panel having a front wall, a right wall, a rear wall, and a left wall;
the front wall being positioned between the left wall and the right wall;
the rear wall being positioned between the left wall and the left wall opposite the front wall;
a plurality of drainage slot being positioned adjacent to the rear edge;
a knife holding slit being positioned between the plurality of drainage slots and the rear edge;
the knife holding slit being narrower than each of the plurality of drainage slots;
the plurality of drainage slots traversing through the upper panel and lower panel of the cutting board; and

10. The food prep board as claimed in claim 8 comprising:
the lower panel comprising a first indent and a second indent;
the left indent being positioned along the left wall where it connects to the front wall;
the right indent being positioned along the right wall where it connects to the front wall;
the tray comprising a base panel, a left barrier, a right barrier, and a rear barrier; and
the base panel having a top side and a bottom side.

11. The food prep board as claimed in claim 10 comprising:
a plurality of slides are spaced across the top side of the tray;
the plurality of slides traversing the length of the top side of the tray; and
the tray further comprising a left mounting post and a right mounting posts.

12. The food prep board as claimed in claim 10 comprising:
the right barrier having a front end and a rear end; and
the left barrier having a front end and a rear end.

13. The food prep board as claimed in claim 12 comprising:
the rear barrier being positioned between the rear end of the left barrier and rear end of the right barrier;
the right mounting post being positioned along the right barrier where it connects to the rear barrier;
the left mounting post being positioned along the left barrier where to connects to the left barrier;
the right mounting post extending inward on the tray;
the left mounting post extending inward on the tray;
the tray having a lip; and
the lip traversing the length of the left barrier, the rear barrier, and the right barrier.

14. A food prep board comprising:
a cutting board;
a tray;
the cutting board configured to rest on top of the tray;
the cutting board further comprising an upper panel and a lower panel;
the upper panel having a left edge, a right edge, a rear edge, and a front brim;
the upper panel having a top surface;
a divot being perimetrically positioned about the top surface;
the upper panel being larger than the lower panel;
the upper panel being centrally positioned on top of the lower panel;
the rear edge being positioned between the left edge and the right edge; and
the front brim being positioned between the left edge and the right edge opposite the rear edge.

15. The food prep board as claimed in claim 14 comprising:
the lower panel having a front wall, a right wall, a rear wall, and a left wall;
the front wall being positioned between the left wall and the right wall;
the rear wall being positioned between the left wall and the left wall opposite the front wall;
the lower panel comprising a right indent and a left indent;
the left indent being positioned along the left wall where it connects to the front wall; and
the right indent being positioned along the right wall where it connects to the front wall.

16. A food prep board as claimed in claim 14 comprising:
a plurality of drainage slot being positioned adjacent to the rear edge;
a knife holding slit being positioned between the plurality of drainage slots and the rear edge;
the knife holding slit being narrower than each of the plurality of drainage slots;
the plurality of drainage slots traversing through the upper panel and lower panel of the cutting board; and
the front brim being positioned between the left edge and the right edge opposite the rear edge.

17. A food prep board as claimed in claim 14 comprising:
the tray comprising a base panel, a left barrier, a right barrier, and a rear barrier;
the base panel having a top side and a bottom side;
a plurality of slides are spaced across the top side of the tray;
the plurality of slides traversing the length of the top side of the tray;
the tray further comprising a left mounting post and a right mounting posts
the right barrier having a front end and a rear end;
the left barrier having a front end and a rear end; and
the rear barrier being positioned between the rear end of the left barrier and rear end of the right barrier.

18. The food prep board as claimed in claim 17 comprising:
the right mounting post being positioned along the right barrier where it connects to the rear barrier; and
the left mounting post being positioned along the left barrier where ti connects to the left barrier.

19. The food prep board as claimed in claim 18 comprising:
the right mounting post extending inward on the tray;
the left mounting post extending inward on the tray;
the tray having a lip; and
the lip traversing the length of the left barrier, the rear barrier, and the right barrier.
